(19) United States
(12) Patent Application Publication
(10) Pub. No.: US 2018/0265049 A1
(43) Pub. Date: Sep. 20, 2018

(54) SENSOR AND CLEANING APPARATUS

(71) Applicant: Ford Global Technologies, LLC, Dearborn, MI (US)

(72) Inventors: David Schmidt, Dearborn, MI (US); Scott Black, Farmington Hills, MI (US)

(73) Assignee: Ford Global Technologies, LLC, Dearborn, MI (US)

(21) Appl. No.: 15/458,285

(22) Filed: Mar. 14, 2017

(51) Int. Cl. B60S 1/60; B60R 11/00; B08B 3/02

(52) U.S. Cl. CPC B60S 1/603; B60R 11/00; B60R 2011/005; B60R 2011/004; B08B 3/02

(57) ABSTRACT

An apparatus includes a sensor supported by a sensor arm, a fan mounted in a position that is fixed relative to the sensor, and a duct. The sensor includes a cylindrical window defining an axis. The duct is positioned to deliver air from the fan toward the cylindrical window. The duct has an opening extending along an arc of a circle centered on the axis.

### BACKGROUND

Autonomous vehicles include a variety of sensors. Some sensors detect internal states of the vehicle, for example, wheel speed, wheel orientation, and engine and transmission variables. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back. Some sensors are communications devices, for example, vehicle-to-infrastructure (V2I) or vehicle-to-vehicle (V2V) devices.

### BRIEF DESCRIPTION OF THE DRAWINGS

FIG. 1 is a perspective view of an example vehicle.

FIG. 2 is a top view of the vehicle.

FIG. 3 is a side view of a portion of the vehicle including a sensor and a cleaning apparatus.

FIG. 4 is a cross-sectional view of the sensor and the cleaning apparatus.

FIG. 5 is a top view of a first example of the sensor and the cleaning apparatus.

FIG. 6 is a top view of a second example of the sensor and the cleaning apparatus.

### DETAILED DESCRIPTION

An apparatus 32 includes a sensor 54 supported by a sensor arm 52, a fan 72 mounted in a position that is fixed relative to the sensor 54, and a duct 74. The sensor 54 includes a cylindrical window 62 defining an axis A. The duct 74 is positioned to deliver air from the fan 72 toward the cylindrical window 62. The duct 74 has an opening 76 extending along an arc of a circle centered on the axis A.

The apparatus 32 may also include the sensor arm 52 extensible from a pillar 36, 38, 40 of a vehicle 30. Additionally, the apparatus 32 may include the pillar 36, 38, 40 of the vehicle 30, and the pillar 36, 38, 40 may extend from a first end 98 at a bottom of a windshield 44 to a second end 100 at a top of the windshield 44, and the sensor arm 52 may be attached to the pillar 36, 38, 40 spaced from the first end 98 and from the second end 100. Additionally, the fan 72 may be disposed beneath the sensor 54.

The opening 76 may be positioned to create an air curtain across the cylindrical window 62 when the fan 72 is operating.

The opening 76 may extend at least 180° about the axis A.

The opening 76 may have a width W that is substantially constant along the arc of the circle.

The apparatus 32 may also include a sprayer 86 coupled to the sensor 54. Additionally, the sprayer 86 may be ring-shaped. Additionally, the cylindrical window 62 has a diameter, and the sprayer 86 may have a diameter larger than the diameter of the cylindrical window 62. Additionally, the sprayer 86 may have a plurality of sprayer nozzles 88 directed toward the cylindrical window 62.

In an alternative embodiment, the apparatus 32 includes the sensor 54 supported by the sensor arm 52, the fan 72 mounted in a position that is fixed relative to the sensor 54, and the duct 74. The sensor 54 has the cylindrical window 62 defining the axis A. The duct 74 is positioned to deliver air from the fan 72 toward the cylindrical window 62. The duct 74 has a plurality of air nozzles 78 each positioned on the circle centered on the axis A.

The apparatus 32 may also include the sensor arm 52 extensible from the pillar 36, 38, 40 of the vehicle 30. Additionally, the apparatus 32 may include the pillar 36, 38, 40 of the vehicle 30, and the pillar 36, 38, 40 may extend from the first end 98 at the bottom of the windshield 44 to the second end 100 at the top of the windshield 44, and the sensor arm 52 may be attached to the pillar 36, 38, 40 spaced from the first end 98 and from the second end 100. Additionally, the fan 72 may be disposed beneath the sensor 54.

The apparatus 32 may also include the sprayer 86 coupled to the sensor 54. Additionally, the sprayer 86 may be ring-shaped. Additionally, the cylindrical window 62 has a diameter, and the sprayer 86 may have a diameter larger than the diameter of the cylindrical window 62. Additionally, the sprayer 86 may have the plurality of sprayer nozzles 88 directed toward the cylindrical window 62.

The apparatus 32 cleans the sensor 54 and may thus allow the sensor 54 to more accurately detect the external environment. The sensor 54 is positioned relative to the rest of the vehicle 30 so as not cause significant drag or increase a height of the vehicle 30 by being located on a roof of the vehicle 30, while still maintaining a wide field of view for the sensor 54. The apparatus 32 is positioned relative to the rest of the vehicle 30 so that the apparatus 32 will not block the field of view of the sensor 54 nor of a human driver of the vehicle 30 who is looking through the windshield 44 or a window 46 of the vehicle 30.

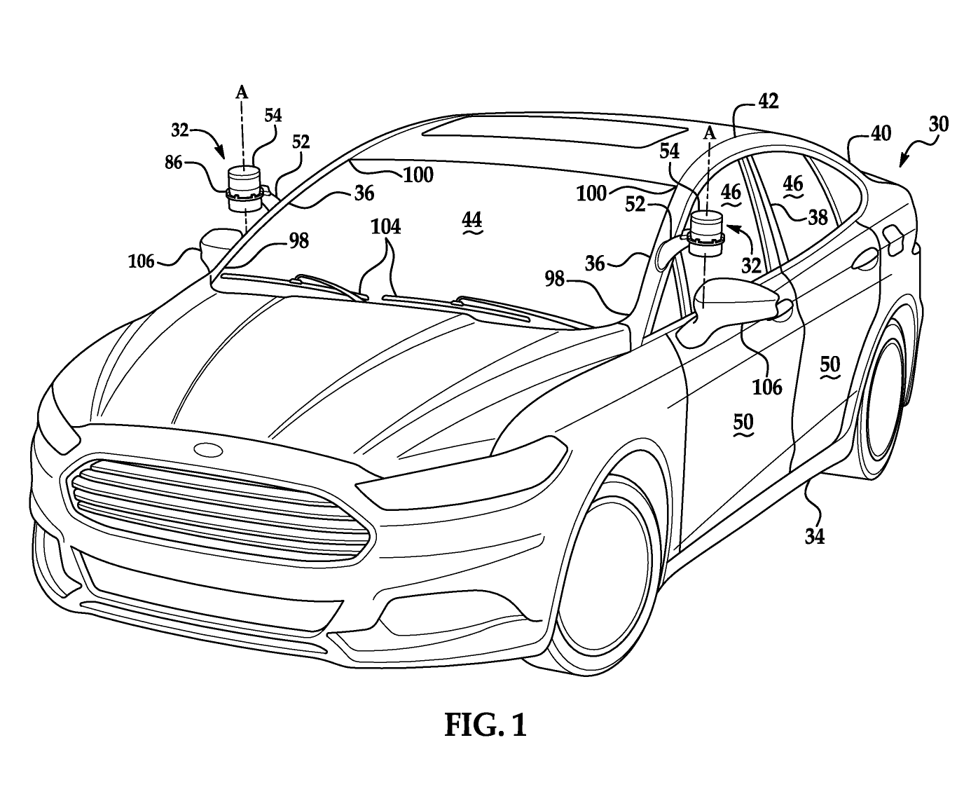

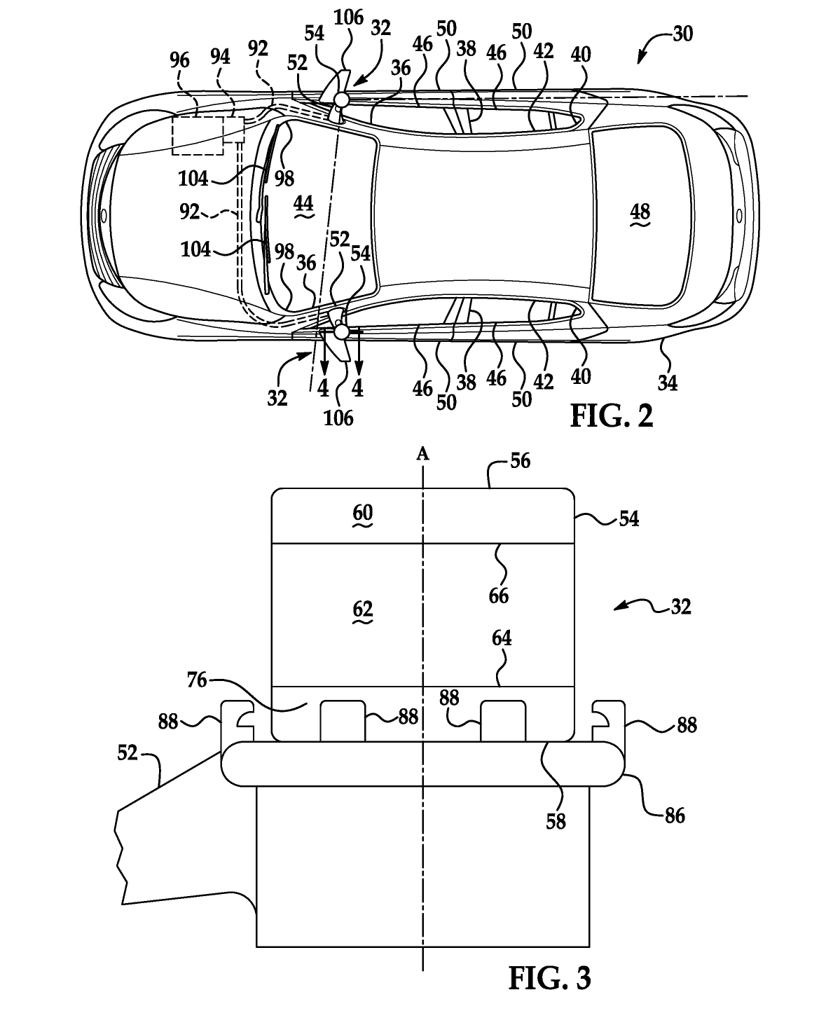

With reference to FIGS. 1 and 2, a body 34 of the vehicle 30 may include A pillars 36, B pillars 38, C pillars 40, and roof rails 42. The A pillars 36 may extend between the windshield 44 and windows 46 and from the first end 98 at a bottom of the windshield 44 to the second end 100 at a top of the windshield 44. The B pillars 38 may extend between the windows 46 of adjacent doors 50. The C pillars 40 may extend between the windows 46 and a backlite 48. The body 34 may also include D pillars (not shown) if the vehicle 30 is, e.g., an SUV, crossover, minivan, or station wagon, in which case the C pillars 40 extend between the windows 46 of rear doors 50 and rear left and right windows 46, and the D pillars extend between the rear right and left windows 46 and the backlite 48. The roof rails 42 extend along the windows 46 from the A pillar 36 to the B pillar 38 to the C pillar 40.

The windshield 44 and windows 46 may be formed of any suitably durable transparent material, including glass such as laminated, tempered glass or plastic such as Plexiglas or polycarbonate. The windshield 44 is located adjacent the A pillars 36.

The vehicle 30 may include side-view mirrors 106. The side-view mirrors 106 may be located on the front doors 50 or on the body 34 near the bottom of the windshield 44. The side-view mirrors 106 may be visible to a human driver through the windows 46 and provide a reflected view of a vehicle-rearward direction to the driver.

With continued reference to FIGS. 1 and 2, the sensor arm 52 extends from one of the pillars 36, 38, 40 of the vehicle 30, e.g., the A pillar 36, to the sensor 54. The sensor arm 52 may be located between the ends 98, 100 of the A pillar 36, that is, spaced from the bottom of the windshield 44 and from the top of the windshield 44, that is, spaced from the first end 98 and from the second end 100. The sensor arm 52 may be attached to a bottom surface 58 of the sensor 54. The sensor arm 52 may have a tubular or other hollow shape, that is, a cavity may extend through the sensor arm 52. The cavity may allow wiring, tubes, etc. to pass through the sensor arm 52 while being shielded from the outside environment.

With reference to FIGS. 1, 3, and 4, the sensor 54 is supported by the sensor arm 52. The sensor 54 may have a cylindrical shape with a top surface 56, the bottom surface 58, and a side surface 60. The top surface 56 faces up, that is, in a vehicle-upward direction, and the bottom surface 58 faces down, that is, in a vehicle-downward direction. The side-view mirrors 106 may be located below the sensors 54, that is, in a vehicle-downward direction from the sensors 54, and each bottom surface 58 may face each side-view mirror. The cylindrical shape of the sensor 54 defines the axis A, which runs through a center of the sensor 54. The axis A is oriented vertically relative to the vehicle 30.

The sensor 54 may be designed to detect features of the outside world; for example, the sensor 54 may be a radar sensor, a scanning laser range finder, a light detection and ranging (LIDAR) device, or an image processing sensor such as a camera. In particular, the sensor 54 may be a LIDAR device. A LIDAR device detects distances to objects by emitting laser pulses and measuring the time of flight for the pulse to travel to the object and back.

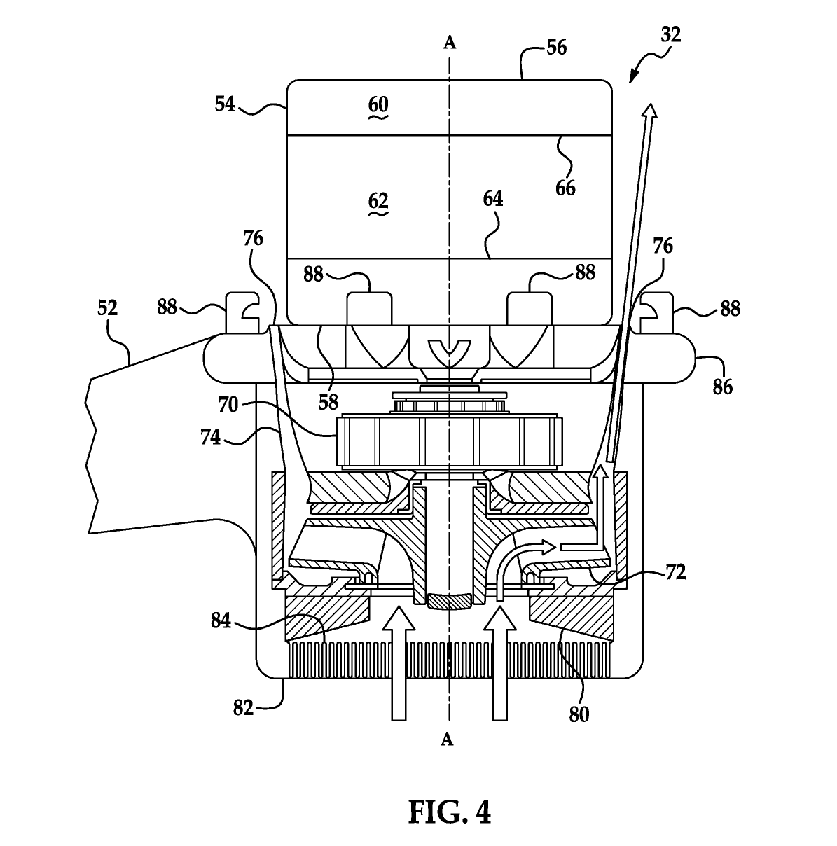

With reference to FIGS. 3 and 4, the side surface 60 may include the cylindrical window 62. The cylindrical window 62 may also define the axis A. The cylindrical window 62 extends about the axis A. The cylindrical window 62 may extend fully about the axis A, that is, 360°, or partially about the axis A. The cylindrical window 62 extends along the axis A from a bottom edge 64 to a top edge 66. The bottom edge 64 may be at the bottom surface 58 or may be spaced from the bottom surface 58 along the side surface 60. The top edge 66 may be at the top surface 56 or may be spaced from the top surface 56 along the side surface 60. The cylindrical window 62 has a diameter. The diameter of the cylindrical window 62 may be the same as the rest of the side surface 60, if any; in other words, the cylindrical window 62 may be flush or substantially flush with the side surface 60. “Substantially flush” means a seam between the cylindrical window 62 and the rest of the side surface 60 does not cause turbulence in air flowing along the side surface 60. At least some of the cylindrical window 62 is transparent with respect to whatever medium the sensor 54 is capable of detecting. For example, if the sensor 54 is a LIDAR device, then the cylindrical window 62 is transparent with respect to visible light.

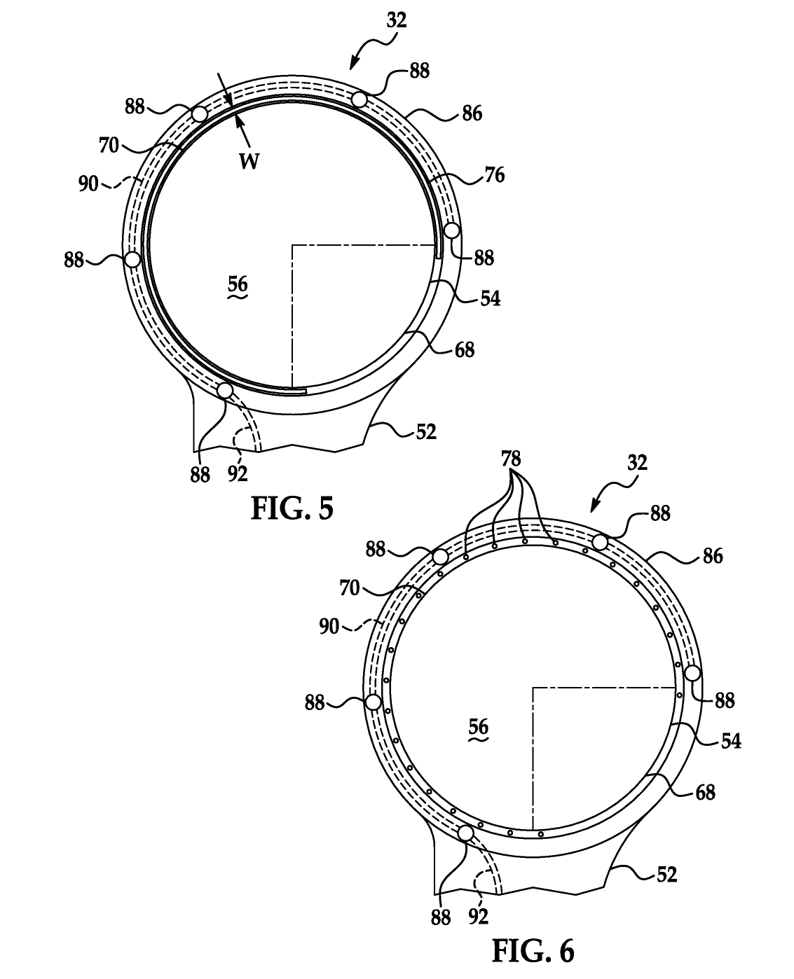

With reference to FIGS. 2, 5, and 6, the cylindrical window 62 has an obstructed portion 68 and a viewing portion 70. The obstructed portion 68 faces the vehicle 30, and the viewing portion 70 faces away from the vehicle 30. In other words, the obstructed portion 68 is the area of the cylindrical window 62 for which the sensor 54 is blocked by the vehicle 30 from detecting the external environment. The viewing portion 70 is the area of the cylindrical window 62 through which the sensor 54 is able to detect the external environment without obstruction by the vehicle 30. If the sensor arm 52 extends from between the ends 98, 100 of the A pillar 36, as shown in FIG. 1, then the viewing portion 70 may be approximately equal to or greater than 270°.

With reference to FIGS. 3-6, the sprayer 86 may be coupled to the sensor 54. The sprayer 86 may be ring-shaped and may have a diameter larger than the diameter of the cylindrical window 62. The sprayer 86 may be spaced from the side surface 60 of the sensor 54, and the duct 74 or the air nozzles 78 may extend or direct air between the sprayer 86 and the side surface 60 of the sensor 54.

The sprayer 86 may have the plurality of sprayer nozzles 88 directed toward the cylindrical window 62 and a channel 90 extending through the sprayer 86 and feeding into the sprayer nozzles 88. The sprayer nozzles 88 may be spaced circumferentially about the sensor 54. The sprayer nozzles 88 may be located on a circle centered on the axis A. The sprayer nozzles 88 may be spaced circumferentially evenly completely or partially about the axis A, or the sprayer nozzles 88 may be more closely spaced on a vehicle-forward side of the sensor 54 than on a vehicle-rearward side of the sensor 54.

With reference to FIG. 1, a supply line 92 may extend from a pump 94 and a reservoir 96 to the sprayer 86. The supply line 92 may be, e.g., a flexible tube. The supply line 92 may extend through the A pillar 36 and through the sensor arm 52 and connect to the channel 90. The reservoir 96 may be a tank fillable with liquid, e.g., washing fluid for window cleaning. The reservoir 96 may also supply washing fluid to sprayers (not shown) directed at the windshield 44. The pump 94 may force the washing fluid through the supply line 92 to the sprayer 86 with sufficient pressure that the washing fluid sprays from the nozzles 88 onto the cylindrical window 62.

With reference to FIG. 4, an inlet 80 may lead from the external environment to the fan 72. The inlet 80 may be a passageway, e.g., a tube. The inlet 80 may have an inlet opening 82 facing the external environment. The inlet opening 82 may face downward, rearward, or between downward and rearward relative to the vehicle 30 so as to reduce the amount of debris from the external environment entering the inlet 80.

The inlet 80 may contain an air filter 84. The air filter 84 may extend across the inlet 80 and may cover a cross-section of the air filter 84 so that air cannot pass around the air filter 84 through the inlet 80. The air filter 84 may be formed of fibrous materials that remove solid particulates, e.g., dust, smog, pollen, etc., from the air.

The fan 72 is mounted in a position that is fixed relative to the sensor 54, for example, beneath the sensor 54. The fan 72 may be disposed between the sensor 54 and the side-view mirror 106. The fan 72 may include an impeller having vanes (not shown) that, when the impeller is rotated, pull air from the inlet 80 and push air toward the opening 76. The fan 72 may be a centrifugal fan (as shown in FIG. 4), an axial-flow fan, a cross-flow fan, or any other type of fan.

With continued reference to FIG. 4, a drive motor 70 may be coupled to the sensor 54 and to the fan 72. The drive motor 70 may be fixed to the bottom surface 58 of the sensor 54, for example, by fastening. The drive motor 70 may be disposed between the sensor 54 and the side-view mirror. The drive motor 70 may be, for example, an electric motor having a rotational output.

The duct 74 is positioned to deliver air from the fan 72 toward the cylindrical window 62. The duct 74 may extend about the axis A. The duct 74 may extend around the drive motor 70. The duct 74 may have a width measured radially with respect to the axis A. The width of the duct 74 may narrow from the fan 72 to the opening 76 or the air nozzles 78.

In a first example of the apparatus 32, the duct 74 may have the opening 76 extending along the arc of the circle centered on the axis A. An “arc of a circle” is a mathematical term referring to a connected section of a circumference of a circle, i.e., a partial circle. The opening 76 may extend fully about the axis A, i.e., 360°, or the opening 76 may extend partially about the axis A. For example, the opening 76 may extend at least 180° about the axis A. The opening 76 has the width W that may be substantially constant along the arc of the circle, that is, difference in air flow through the opening 76 at different points about the circle is negligible. The opening 76 is positioned to create an air curtain across the cylindrical window 62 when the fan 72 is operating. An “air curtain” is a layer of moving air. In other words, the airflow from the opening 76 travels vertically across the cylindrical window 62 and substantially covers, that is, covers most of, the cylindrical window 62 or the viewing portion 70 of the cylindrical window 62. “Across” means from one side of something to the other side. The air curtain serves as a barrier and may deflect debris or other potential obstructions from contacting the cylindrical window 62.

In a second example of the apparatus 32, the duct 74 may have the plurality of air nozzles 78 each positioned on a circle centered on the axis A. The air nozzles 78 may be spaced circumferentially about the sensor 54. The air nozzles 78 may be spaced evenly about the axis A or partially about the axis A, or the air nozzles 78 may be more closely spaced on a vehicle-forward side of the sensor 54 than on a vehicle-rearward side of the sensor 54. The air nozzles 78 may be positioned to create an air curtain across the cylindrical window 62 when the fan 72 is operating. In other words, the airflow from the air nozzles 78 travels vertically across the cylindrical window 62, that is, from the bottom edge 64 to the top edge 66, and substantially covers the cylindrical window 62 or the viewing portion 70 of the cylindrical window 62.

In operation, when the vehicle 30 is in operation and traveling forward, the drive motor 70 drives the fan 72. The fan 72 pulls air through the air filter 84 and the inlet 80 and pushes the air into the duct 74. The duct 74 redirects the air through the opening 76 or the air nozzles 78. The air flows continuously across the cylindrical window 62. The continuous airflow may deflect dirt, particles, etc. from contacting the cylindrical window 62, keeping the cylindrical window 62 clear and facilitating the operation of the sensor 54. If an obstruction does land and stick on the cylindrical window 62, the sprayer 86 may be used to wash away the obstruction.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. An apparatus, comprising:
a sensor supported by a sensor arm and including a cylindrical window defining an axis;
a fan mounted in a position that is fixed relative to the sensor; and
a duct positioned to deliver air from the fan toward the cylindrical window, the duct having an opening extending along an arc of a circle centered on the axis.

2. The apparatus of claim 1, further comprising the sensor arm extensible from a pillar of a vehicle.

3. The apparatus of claim 2, further comprising the pillar of the vehicle, wherein the pillar extends from a first end at a bottom of a windshield to a second end at a top of the windshield, and the sensor arm is attached to the pillar spaced from the first end and from the second end.

4. The apparatus of claim 3, wherein the fan is disposed beneath the sensor.

5. The apparatus of claim 1, wherein the opening is positioned to create an air curtain across the cylindrical window when the fan is operating.

6. The apparatus of claim 1, wherein the opening extends at least 180° about the axis.

7. The apparatus of claim 1, wherein the opening has a width that is substantially constant along the arc of the circle.

8. The apparatus of claim 1, further comprising a sprayer coupled to the sensor.

9. The apparatus of claim 8, wherein the sprayer is ring-shaped.

10. The apparatus of claim 9, wherein the cylindrical window has a diameter, and the sprayer has a diameter larger than the diameter of the cylindrical window.

11. The apparatus of claim 10, wherein the sprayer has a plurality of sprayer nozzles directed toward the cylindrical window.

12. An apparatus, comprising:
a sensor supported by a sensor arm and including a cylindrical window defining an axis;
a fan mounted in a position that is fixed relative to the sensor; and
a duct positioned to deliver air from the fan toward the cylindrical window, the duct having a plurality of air nozzles each positioned on a circle centered on the axis.

13. The apparatus of claim 12, further comprising the sensor arm extensible from a pillar of a vehicle.

14. The apparatus of claim 13, further comprising the pillar of the vehicle, wherein the pillar extends from first end at a bottom of a windshield to a second end at a top of the windshield, and the sensor arm is attached to the pillar spaced from the first end and from the second end.

15. The apparatus of claim 14, wherein the fan is disposed beneath the sensor.

16. The apparatus of claim 12, wherein the air nozzles are positioned to create an air curtain across the cylindrical window when the fan is operating.

17. The apparatus of claim 12, further comprising a sprayer coupled to the sensor.

18. The apparatus of claim 17, wherein the sprayer is ring-shaped.

19. The apparatus of claim 18, wherein the cylindrical window has a diameter, and the sprayer has a diameter larger than the diameter of the cylindrical window.

20. The apparatus of claim 19, wherein the sprayer has a plurality of sprayer nozzles directed toward the cylindrical window.
